(19) United States
(12) Patent Application Publication
(10) Pub. No.: US 2026/0080617 A1
(43) Pub. Date: Mar. 19, 2026

(54) POINT CLOUD PROCESSING DEVICE AND POINT CLOUD PROCESSING METHOD

(71) Applicants: Hon Hai Precision Industry Co., Ltd., New Taipei City (TW); FOXCONN TECHNOLOGY GROUP CO., LTD, Shenzhen (CN)

(72) Inventors: Yung-Hui Li, New Taipei City (TW); Shen-Hsuan Liu, New Taipei City (TW); Yi-Rong Lin, New Taipei City (TW); Kai-Lin Yang, New Taipei City (TW); Xiaoyun Dong, New Taipei City (TW); Jianping Wang, New Taipei City (TW)

(73) Assignees: Hon Hai Precision Industry Co., Ltd., New Taipei City (TW); FOXCONN TECHNOLOGY GROUP CO., LTD, Shenzhen (CN)

(21) Appl. No.: 19/324,151

(22) Filed: Sep. 10, 2025

Related U.S. Application Data
(60) Provisional application No. 63/694,910, filed on Sep. 15, 2024.

(51) Int. Cl. G06T 17/00; G01S 17/89; G06T 15/06

(52) U.S. Cl. CPC G06T 17/00; G01S 17/89; G06T 15/06

(57) ABSTRACT

A point cloud processing device and a point cloud processing method are provided. The point cloud processing method includes: receiving a vertically scanned point cloud; performing a random sample consensus algorithm on the vertically scanned point cloud to obtain a fitting plane; filtering a first ground point of the vertically scanned point cloud according to the fitting plane to update the vertically scanned point cloud; and generating a processed point cloud according to the updated vertically scanned point cloud and outputting the processed point cloud.

### CROSS-REFERENCE TO RELATED APPLICATION

This application claims the priority benefit of U.S. provisional application Ser. No. 63/694,910, filed on Sep. 15, 2024. The entirety of the above-mentioned patent application is hereby incorporated by reference herein and made a part of this specification.

### BACKGROUND

### Technical Field

The disclosure relates to a data processing technology, and in particular to a point cloud processing device and a point cloud processing method.

### Related Art

A LiDAR system has broad application prospects in fields such as autonomous driving. If a vehicle is only provided with a single LiDAR (for example, top LiDAR), the LiDAR system may have many blind spots. To reduce the blind spots and increase safety, the LiDAR system may extract multiple point clouds by multiple LiDARs and execute multi-LiDAR sensor fusion to merge the point clouds. However, the method of merging the point clouds often results in excessively large data quantity, which is not conducive to real-time processing of data. In addition, different LiDARs of the LiDAR system may be disposed on the vehicle in different manners, causing the point cloud data extracted by different LiDARs to have different characteristics. If the same filtering algorithm is used for all point cloud data, poor performance of the filtering algorithm may occur.

### SUMMARY

The disclosure provides a point cloud processing device and a point cloud processing method, which may filter a ground point of a point cloud having different characteristics.

A point cloud processing device of the disclosure includes a processor and a transceiver. The transceiver receives a vertically scanned point cloud. The processor is coupled to the transceiver and is configured to execute following steps. A random sample consensus algorithm is performed on the vertically scanned point cloud to obtain a fitting plane. A first ground point of the vertically scanned point cloud is filtered according to the fitting plane to update the vertically scanned point cloud. A processed point cloud is generated according to the updated vertically scanned point cloud, and outputted through the transceiver.

In an embodiment of the disclosure, the processor is configured to further execute following steps. A horizontally scanned point cloud is received through the transceiver. Ray ground filtering is performed on the horizontally scanned point cloud to filter a second ground point of the horizontally scanned point cloud to update the horizontally scanned point cloud. Data fusion is performed on the updated vertically scanned point cloud and the updated horizontally scanned point cloud to generate the processed point cloud.

In an embodiment of the disclosure, the ray ground filtering includes following steps. A first point corresponding to a first distance and a second point corresponding to a second distance are obtained from the horizontally scanned point cloud, where the second distance is greater than the first distance. A first angle between the first point and a reference plane and a second angle between the second point and the reference plane are determined. A difference between the first angle and the second angle is calculated. In response to the difference being less than a first threshold and the second angle being less than a second threshold, the second point is determined as a second ground point.

In an embodiment of the disclosure, the horizontally scanned point cloud corresponds to a field of view of a LiDAR, where the processor is configured to further execute following steps. A region in the field of view is obtained according to a single scan direction of the LiDAR. The first point and the second point are obtained from the region.

In an embodiment of the disclosure, the LiDAR configured to generate the horizontally scanned point cloud is a rotary LiDAR, where a rotating shaft of the rotary LiDAR is perpendicular to a ground.

In an embodiment of the disclosure, the processor is configured to further execute following steps. Occupancy estimation is performed on the processed point cloud to generate an occupancy map. A control signal of the vehicle is generated according to the occupancy map, and outputted through the transceiver.

In an embodiment of the disclosure, the processor is configured to further execute following steps. The vertically scanned point cloud and the horizontally scanned point cloud are concatenated to generate a concatenated point cloud. Object detection is performed on the concatenated point cloud to generate a boundary box. The control signal is generated according to the boundary box and the occupancy map.

In an embodiment of the disclosure, the random sample consensus algorithm includes following steps. Multiple fitting planes are generated according to the vertically scanned point cloud, where the fitting planes respectively correspond to multiple point quantities. In response to a first point quantity of a fitting plane being a maximum point quantity among the point quantities, the fitting plane is selected from the fitting planes.

In an embodiment of the disclosure, the processor is configured to further execute following steps. Whether a distance between a first point of the vertically scanned point cloud and the fitting plane is less than a threshold is determined. In response to the distance being less than the threshold, the first point is determined as a first ground point.

In an embodiment of the disclosure, the LiDAR configured to generate the vertically scanned point cloud is a rotary LiDAR, where a rotating shaft of the rotary LiDAR is parallel to a ground.

A point cloud processing method of the disclosure includes following steps. The vertically scanned point cloud is received. The random sample consensus algorithm is performed on the vertically scanned point cloud to obtain a fitting plane. The first ground point of the vertically scanned point cloud is filtered according to the fitting plane to update the vertically scanned point cloud. The processed point cloud is generated according to the updated vertically scanned point cloud, and outputted.

In an embodiment of the disclosure, the point cloud processing method further includes following steps. The horizontally scanned point cloud is received. The ray ground filtering is performed on the horizontally scanned point cloud to filter a second ground point of the horizontally scanned point cloud to update the horizontally scanned point cloud. The data fusion is performed on the updated vertically scanned point cloud and the updated horizontally scanned point cloud to generate the processed point cloud.

In an embodiment of the disclosure, the step of performing the ray ground filtering on the horizontally scanned point cloud to filter the second ground point of the horizontally scanned point cloud to update the horizontally scanned point cloud includes following steps. The first point corresponding to the first distance and the second point corresponding to the second distance from the horizontally scanned point cloud are obtained, where the second distance is greater than the first distance. The first angle between the first point and the reference plane and the second angle between the second point and the reference plane are determined. The difference between the first angle and the second angle is calculated. In response to the difference being less than a first threshold and the second angle being less than the second threshold, the second point is determined as a second ground point.

In an embodiment of the disclosure, the horizontally scanned point cloud corresponds to the field of view of the LiDAR, where the step of obtaining the first point corresponding to the first distance and the second point corresponding to the second distance from the horizontally scanned point cloud includes following steps. The region in the field of view is obtained according to a single scan direction of the LiDAR. The first point and the second point are obtained from the region.

In an embodiment of the disclosure, the LiDAR configured to generate the horizontally scanned point cloud is a rotary LiDAR, where the rotating shaft of the rotary LiDAR is perpendicular to the ground.

In an embodiment of the disclosure, the point cloud processing method further includes following steps. The occupancy estimation is performed on the processed point cloud to generate the occupancy map. The control signal of the vehicle is generated according to the occupancy map, and outputted.

In an embodiment of the disclosure, the step of generating the control signal of the vehicle according to the occupancy map includes following steps. The vertically scanned point cloud and the horizontally scanned point cloud are concatenate to generate the concatenated point cloud. The object detection is performed on the concatenated point cloud to generate the boundary box. The control signal is generated according to the boundary box and the occupancy map.

In an embodiment of the disclosure, the step of performing the random sample consensus algorithm on the vertically scanned point cloud to obtain the fitting plane includes following steps. The fitting planes are generated according to the vertically scanned point cloud, where the fitting planes respectively correspond to multiple point quantities. In response to the first point quantity of the fitting plane being a maximum point quantity among the point quantities, the fitting plane is selected from the fitting planes.

In an embodiment of the disclosure, the step of filtering the first ground point of the vertically scanned point cloud according to the fitting plane to update the vertically scanned point cloud includes following steps. Whether the distance between the first point in the vertically scanned point cloud and the fitting plane is less than the threshold is determined. In response to the distance being less than the threshold, the first point is determined as the first ground point.

In an embodiment of the disclosure, the LiDAR configured to generate the vertically scanned point cloud is the rotary LiDAR, where the rotating shaft of the rotary LiDAR is parallel to the ground.

Based on the above, the point cloud processing device of the disclosure may filter the ground points of the horizontally scanned point cloud and the vertically scanned point cloud by different algorithms, thereby reducing the data quantity of point cloud data that needs to be processed by the autonomous driving system.

### BRIEF DESCRIPTION OF THE DRAWINGS

FIG. 1 is a schematic view of a point cloud processing device according to an embodiment of the disclosure.

FIG. 2 is a schematic view of a vehicle and LiDAR according to an embodiment of the disclosure.

FIG. 3 is a flowchart of point cloud processing according to an embodiment of the disclosure.

FIG. 4 is a top view of a vehicle and LiDAR according to an embodiment of the disclosure.

FIG. 5 is a flowchart of a point cloud processing method according to an embodiment of the disclosure.

### DESCRIPTION OF THE EMBODIMENTS

In order to make the content of the disclosure more comprehensible, the following specific embodiments are provided as examples according to which the disclosure may indeed be implemented. In addition, wherever possible, elements/components/steps using the same reference numerals in the drawings and embodiments represent the same or similar parts.

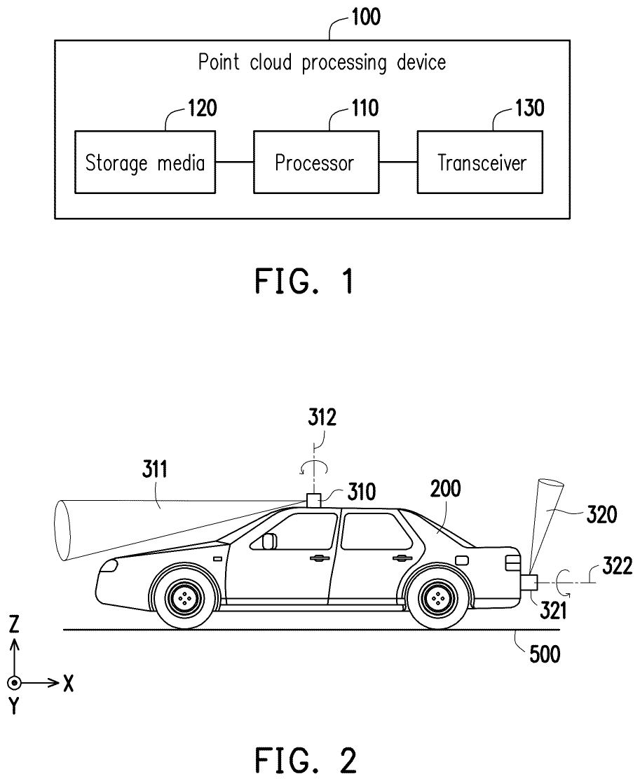

FIG. 1 is a schematic view of a point cloud processing device according to an embodiment of the disclosure. A point cloud processing device 100 may include a processor 110, a storage media 120, and a transceiver 130.

The processor 110 is, for example, a central processing unit (CPU), a programmable micro control unit (MCU) for a common purpose or a specific purpose, a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), other similar elements, or a combination thereof. The processor 110 may be coupled to the storage media 120 and the transceiver 130, and access and execute multiple modules and various application programs stored in the storage media 120.

The storage media 120 is, for example, any type of a fixed or removable random access memory (RAM), read-only memory (ROM), flash memory, hard disk drive (HDD), solid state drive (SSD), similar elements, or a combination thereof, and is configured to store multiple modules or various application programs that may be executed by the processor 110.

The transceiver 130 transmits or receives signals in a wireless or wired manner. The transceiver 130 may further perform operations such as low noise amplification, impedance matching, frequency mixing, up or down frequency conversion, filtering, or amplification. The processor 110 may communicate with an external electronic device through the transceiver 130.

In an embodiment, the processor 110 may communicate with a LiDAR through the transceiver 130 and receive point cloud data extracted by the LiDAR from the LiDAR. The point cloud processing device 100 may be a local device. For example, if the LiDAR is disposed on a vehicle, the point cloud processing device 100 may be disposed in the vehicle. In another aspect, the point cloud processing device 100 may be a remote device. For example, the point cloud processing device 100 may communicate with the LiDAR through a wireless network to receive data from the LiDAR.

According to different installation manners of the LiDAR, the point cloud extracted by the LiDAR may have different characteristics. FIG. 2 is a schematic view of a vehicle 200 and the LiDAR according to an embodiment of the disclosure. To achieve an autonomous driving system or a collision avoidance system, the vehicle 200 may be disposed with multiple LiDARs. For example, the top of the vehicle 200 may be disposed with a LiDAR 310 for detecting information of a larger range of an environment. For regions closer to the vehicle 200, the LiDAR 310 may have blind spots. Accordingly, sides of the vehicle 200 may be disposed with one or multiple LiDARs 320 for blind filling. The LiDAR 320 may be configured to detect information of the environment closer to the vehicle 200.

The LiDAR 310 may include a rotary LiDAR. A detection beam 311 of the LiDAR 310 may rotate around a rotating shaft 312. Assuming that a ground 500 where the vehicle 200 is located is parallel to an XY plane of the Cartesian coordinate system. The rotating shaft 312 of the LiDAR 310 may be parallel to a Z axis. That is, the rotating shaft 312 may be perpendicular to the ground 500. The point cloud extracted by the LiDAR 310 disposed in the aforementioned manner may be a horizontally scanned point cloud.

The LiDAR 320 may include a rotary LiDAR. A detection beam 321 of the LiDAR 320 may rotate around the rotating shaft 322. The rotating shaft 322 of the LiDAR 320 is parallel to the XY plane. That is, the rotating shaft 322 may be parallel to the ground 500. The point cloud extracted by the LiDAR 320 disposed in the aforementioned manner may be a vertically scanned point cloud.

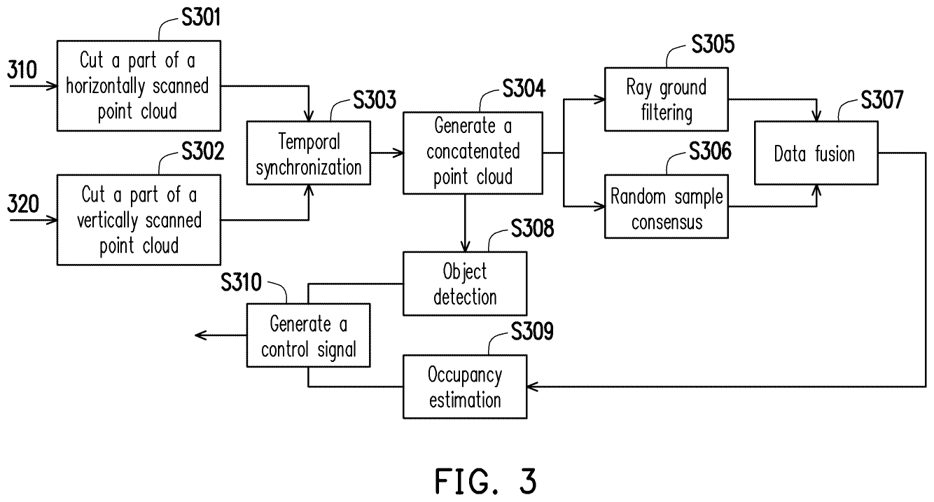

FIG. 3 is a flowchart of point cloud processing according to an embodiment of the disclosure. The steps of the point cloud processing may be implemented by the point cloud processing device 100 as shown in FIG. 1. In step S301, the processor 110 may receive a raw horizontally scanned point cloud from the LiDAR 310 through the transceiver 130. The processor 110 may cut a part of the horizontally scanned point cloud to perform signal processing.

In step S302, the processor 110 may receive a raw vertically scanned point cloud from the LiDAR 320 through the transceiver 130. The processor 110 may cut a part of the vertically scanned point cloud to perform signal processing.

In step S303, the processor 110 may perform temporal synchronization to the horizontally scanned point cloud and the vertically scanned point cloud. The processor 110 aligns the timesteps of the horizontally scanned point cloud and the vertically scanned point cloud to ensure that the horizontally scanned point cloud and the vertically scanned point cloud processed in subsequent steps correspond to the same time point.

In step S304, the processor 110 may concatenate the vertically scanned point cloud and the horizontally scanned point cloud to generate a concatenated point cloud. The processor 110 may convert the vertically scanned point cloud and the horizontally scanned point cloud to the same coordinate system. Next, the processor 110 may take the union of the vertically scanned point cloud and the horizontally scanned point cloud to generate the concatenated point cloud. In an embodiment, each point of the concatenated point cloud may have a corresponding label. The label may indicate that the point belongs to the vertically scanned point cloud or the horizontally scanned point cloud.

In step S305, the processor 110 may obtain the horizontally scanned point cloud from step S303 or obtain the horizontally scanned point cloud from the concatenated point cloud. The processor 110 may perform ray ground filtering on the horizontally scanned point cloud to filter the ground point (for example, a point generated by scanning the ground 500) of the horizontally scanned point cloud, thereby updating the horizontally scanned point cloud to reduce the data quantity.

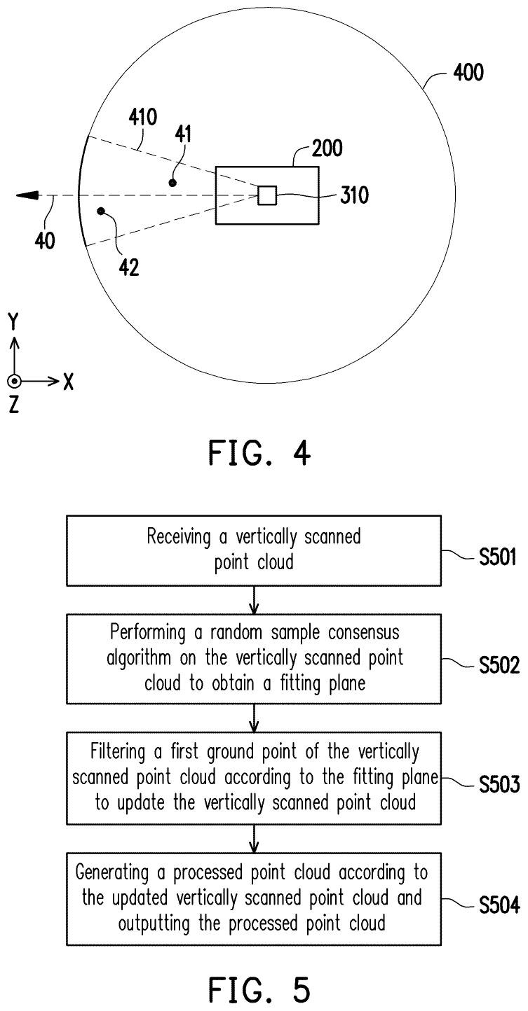

Specifically, the processor 110 may obtain a region in the field of view (FoV) of the LiDAR according to a single scan direction of the LiDAR. FIG. 4 is a top view of the vehicle 200 and the LiDAR 310 according to an embodiment of the disclosure. The LiDAR 310 may extract the horizontally scanned point cloud from the field of view 400. The processor 110 may obtain a region 410 in the field of view 400 according to a single scan direction 40 of the LiDAR 310. The region 410 may be a sector region.

Subsequently, the processor 110 may obtain a point 41 and a point 42 from the horizontally scanned point cloud within the region 410. A distance between the point 41 and the LiDAR 310 may be smaller than a distance between the point 42 and the LiDAR 310. The processor 110 may determine an angle θ1 (for example, an angle formed by the reference plane, the point 41, and the LiDAR 310) between the point 41 and a reference plane (for example, a fitting plane corresponding to the ground 500 generated according to the point cloud), and may determine an angle θ2 (for example, an angle formed by the reference plane, the point 42, and the LiDAR 310) between the point 42 and the reference plane. The processor 110 may calculate a difference between the angle θ1 and the angle θ2.

If the difference between the angle θ1 and the angle θ2 is smaller than a first threshold and the angle θ2 is smaller than a second threshold, it is shown that the point 41 and the point 42 may be on the same plane, and the point 42 may be very close to the ground 500. Accordingly, the processor 110 may determine that the point 42 is a ground point. The processor 110 may filter the point 42 from the horizontally scanned point cloud to reduce the data quantity of the horizontally scanned point cloud (or the concatenated point cloud). If the difference between the angle θ1 and the angle θ2 is greater than or equal to the first threshold, or the angle θ2 is greater than or equal to the second threshold, then the processor 110 may determine that the point 42 is not a ground point. Accordingly, the processor 110 may not filter the point 42.

Returning to FIG. 3, in step S306, the processor 110 may obtain the vertically scanned point cloud from step S303 or obtain the vertically scanned point cloud from the concatenated point cloud. The processor 110 may perform a random sample consensus (RANSAC) algorithm on the vertically scanned point cloud to filter the ground point of the vertically scanned point cloud, thereby updating the vertically scanned point cloud to reduce the data quantity.

The processor 110 may obtain a fitting plane corresponding to the ground 500 according to the vertically scanned point cloud. Specifically, the processor 110 may generate multiple candidate fitting planes according to the vertically scanned point cloud. The candidate fitting planes may respectively correspond to multiple point quantities. The processor 110 may select a fitting plane having a maximum point quantity from the candidate fitting planes. The selected fitting plane is the fitting plane corresponding to the ground 500.

After selecting the fitting plane, the processor 110 may determine a distance between a point in the fitting plane and the fitting plane. If the distance between the point and the fitting plane is smaller than a threshold, it is shown that the point is very close to the ground 500. Accordingly, the processor 110 may determine that the point is a ground point, and may filter the point from the vertically scanned point cloud to reduce the data quantity of the vertically scanned point cloud (or the concatenated point cloud). If the distance between the point and the fitting plane is greater than or equal to the threshold, then the processor 110 may determine that the point is not a ground point. Accordingly, the processor 110 may not filter the point.

After obtaining the updated horizontally scanned point cloud and the updated vertically scanned point cloud, in step S307, the processor 110 may perform data fusion on the updated horizontally scanned point cloud and the updated vertically scanned point cloud to generate a processed point cloud. The processor 110 may output the processed point cloud through the transceiver 130. For example, the processor 110 may output the processed point cloud to the autonomous driving system or the collision avoidance system.

In step S308, the processor 110 may perform object detection on the concatenated point cloud to generate a bounding box. The bounding box may be configured to indicate an object (for example, a dynamic object or a non-environmental object) in the environment. In addition to the bounding box, a result of the object detection may further include a type, position, size, or posture of the object.

In step S309, the processor 110 may perform occupancy estimation on the processed point cloud to generate an occupancy map. The occupancy map may include a point cloud for indicating static objects or environmental objects (for example, ground, walls, safety islands, or street lights).

In step S310, the processor 110 may generate a control signal according to the detection result (for example, the bounding box) of the object or the occupancy map, and output the control signal through the transceiver 130. For example, the processor 110 may output the control signal to the autonomous driving system of the vehicle 200 to control the movement of the vehicle 200 through the control signal.

FIG. 5 is a flowchart of a point cloud processing method according to an embodiment of the disclosure. The point cloud processing method may be implemented by the point cloud processing device 100 as shown in FIG. 1. In step S501, the vertically scanned point cloud is received. In step S502, the RANSAC algorithm is performed on the vertically scanned point cloud to obtain the fitting plane. In step S503, the first ground point of the vertically scanned point cloud is filtered according to the fitting plane to update the vertically scanned point cloud. In step S504, the processed point cloud is generated according to the updated vertically scanned point cloud, and outputted.

In summary, the point cloud processing device of the disclosure may filter the ground points of the horizontally scanned point cloud and the vertically scanned point cloud by different algorithms. The point cloud processing device may perform the ground point filtering on the vertically scanned point cloud by the RANSAC algorithm, and may perform the ground point filtering on the horizontally scanned point cloud by the ray ground filtering. The point cloud processing device may perform the data fusion on the filtered horizontally scanned point cloud and vertically scanned point cloud to generate the processed point cloud. Compared to conventional methods, the point cloud processing device of the disclosure may correctly filter the ground point and may significantly reduce the data quantity of the processed point cloud, thereby facilitating real-time processing of data of the point cloud by the autonomous driving system.

What is claimed is:

1. A point cloud processing device, comprising:
a transceiver, receiving a vertically scanned point cloud; and
a processor, coupled to the transceiver, and configured to execute:
performing a random sample consensus algorithm on the vertically scanned point cloud to obtain a fitting plane;
filtering a first ground point of the vertically scanned point cloud according to the fitting plane to update the vertically scanned point cloud; and
generating a processed point cloud according to the updated vertically scanned point cloud, and outputting the processed point cloud through the transceiver.

2. The point cloud processing device according to claim 1, wherein the processor is configured to further execute:
receiving a horizontally scanned point cloud through the transceiver;
performing ray ground filtering on the horizontally scanned point cloud to filter a second ground point of the horizontally scanned point cloud to update the horizontally scanned point cloud; and
performing data fusion on the updated vertically scanned point cloud and the updated horizontally scanned point cloud to generate the processed point cloud.

3. The point cloud processing device according to claim 2, wherein the ray ground filtering comprises:
obtaining a first point corresponding to a first distance and a second point corresponding to a second distance from the horizontally scanned point cloud, wherein the second distance is greater than the first distance;
determining a first angle between the first point and a reference plane and a second angle between the second point and the reference plane;
calculating a difference between the first angle and the second angle; and
in response to the difference being less than a first threshold and the second angle being less than a second threshold, determining the second point as the second ground point.

4. The point cloud processing device according to claim 3, wherein the horizontally scanned point cloud corresponds to a field of view of a LiDAR, and the processor is configured to further execute:
obtaining a region in the field of view according to a single scan direction of the LiDAR; and
obtaining the first point and the second point from the region.

5. The point cloud processing device according to claim 2, wherein a LiDAR configured to generate the horizontally scanned point cloud is a rotary LiDAR, and a rotating shaft of the rotary LiDAR is perpendicular to a ground.

6. The point cloud processing device according to claim 2, wherein the processor is configured to further execute:
performing occupancy estimation on the processed point cloud to generate an occupancy map; and
generating a control signal of a vehicle according to the occupancy map, and outputting the control signal through the transceiver.

7. The point cloud processing device according to claim 6, wherein the processor is configured to further execute:
concatenating the vertically scanned point cloud and the horizontally scanned point cloud to generate a concatenated point cloud;
performing object detection on the concatenated point cloud to generate a bounding box; and
generating the control signal according to the bounding box and the occupancy map.

8. The point cloud processing device according to claim 1, wherein the random sample consensus algorithm comprises:
generating a plurality of fitting planes according to the vertically scanned point cloud, wherein the plurality of fitting planes respectively correspond to a plurality of point quantities; and
in response to a first point quantity of the fitting plane being a maximum point quantity among the plurality of point quantities, selecting the fitting plane from the plurality of fitting planes.

9. The point cloud processing device according to claim 8, wherein the processor is configured to further execute:
determining whether a distance between a first point of the vertically scanned point cloud and the fitting plane is less than a threshold; and
in response to the distance being less than the threshold, determining the first point as the first ground point.

10. The point cloud processing device according to claim 1, wherein a LiDAR configured to generate the vertically scanned point cloud is a rotary LiDAR, and a rotating shaft of the rotary LiDAR is parallel to a ground.

11. A point cloud processing method, comprising:
receiving a vertically scanned point cloud;
performing a random sample consensus algorithm on the vertically scanned point cloud to obtain a fitting plane;
filtering a first ground point of the vertically scanned point cloud according to the fitting plane to update the vertically scanned point cloud; and
generating a processed point cloud according to the updated vertically scanned point cloud, and outputting the processed point cloud.

12. The point cloud processing method according to claim 11, further comprising:
receiving a horizontally scanned point cloud;
performing ray ground filtering on the horizontally scanned point cloud to filter a second ground point of the horizontally scanned point cloud to update the horizontally scanned point cloud; and
performing data fusion on the updated vertically scanned point cloud and the updated horizontally scanned point cloud to generate the processed point cloud.

13. The point cloud processing method according to claim 12, wherein the step of performing the ray ground filtering on the horizontally scanned point cloud to filter the second ground point of the horizontally scanned point cloud to update the horizontally scanned point cloud comprises:
obtaining a first point corresponding to a first distance and a second point corresponding to a second distance from the horizontally scanned point cloud, wherein the second distance is greater than the first distance;
determining a first angle between the first point and a reference plane and a second angle between the second point and the reference plane;
calculating a difference between the first angle and the second angle; and
in response to the difference being less than a first threshold and the second angle being less than a second threshold, determining the second point as the second ground point.

14. The point cloud processing method according to claim 13, wherein the horizontally scanned point cloud corresponds to a field of view of a LiDAR, wherein the step of obtaining the first point corresponding to the first distance and the second point corresponding to the second distance from the horizontally scanned point cloud comprises:
obtaining a region in the field of view according to a single scan direction of the LiDAR; and
obtaining the first point and the second point from the region.

15. The point cloud processing method according to claim 12, wherein a LiDAR configured to generate the horizontally scanned point cloud is a rotary LiDAR, and a rotating shaft of the rotary LiDAR is perpendicular to a ground.

16. The point cloud processing method according to claim 12, further comprising:
performing occupancy estimation on the processed point cloud to generate an occupancy map; and
generating a control signal of a vehicle according to the occupancy map, and outputting the control signal.

17. The point cloud processing method according to claim 16, wherein the step of generating the control signal of the vehicle according to the occupancy map comprises:
concatenating the vertically scanned point cloud and the horizontally scanned point cloud to generate a concatenated point cloud;
performing object detection on the concatenated point cloud to generate a bounding box; and
generating the control signal according to the bounding box and the occupancy map.

18. The point cloud processing method according to claim 11, wherein the step of executing the random sample consensus algorithm on the vertically scanned point cloud to obtain the fitting plane comprises:
generating a plurality of fitting planes according to the vertically scanned point cloud, wherein the plurality of fitting planes respectively correspond to a plurality of point quantities; and
in response to a first point quantity of the fitting plane being a maximum point quantity among the plurality of point quantities, selecting the fitting plane from the plurality of fitting planes.

19. The point cloud processing method according to claim 18, wherein the step of filtering the first ground point of the vertically scanned point cloud according to the fitting plane to update the vertically scanned point cloud comprises:
determining whether a distance between a first point of the vertically scanned point cloud and the fitting plane is less than a threshold; and
in response to the distance being less than the threshold, determining the first point as the first ground point.

20. The point cloud processing method according to claim 11, wherein a LiDAR configured to generate the vertically scanned point cloud is a rotary LiDAR, and a rotating shaft of the rotary LiDAR is parallel to a ground.
